(19) United States
(12) Patent Application Publication
(10) Pub. No.: US 2025/0174398 A1
(43) Pub. Date: May 29, 2025

(54) MULTILAYER CERAMIC CAPACITOR AND CIRCUIT BOARD

(71) Applicant: TAIYO YUDEN CO., LTD., Tokyo (JP)

(72) Inventor: Mina AMANO, Tokyo (JP)

(73) Assignee: TAIYO YUDEN CO., LTD., Tokyo (JP)

(21) Appl. No.: 19/030,265

(22) Filed: Jan. 17, 2025

Related U.S. Application Data
(63) Continuation of application No. 18/185,798, filed on Mar. 17, 2023, now abandoned.

(30) Foreign Application Priority Data
Mar. 22, 2022 (JP) 2022-044811

(51) Int. Cl. H01G 4/008; H01G 2/06; H01G 4/232; H01G 4/30

(52) U.S. Cl. CPC H01G 4/008; H01G 2/06; H01G 4/232; H01G 4/30

(57) ABSTRACT

A multilayer ceramic capacitor includes a ceramic body and first and second external electrodes. The ceramic body has a capacitance forming portion including first and second internal electrodes and ceramic layers. Each of the first and second internal electrodes has a first region arranged along margin portions of the ceramic body and a second region arranged at inner sides of the first region. Each of the first and second internal electrodes includes a conductive component, and a continuity rate of the conductive component in a plan view as seen from the second axial direction in the first region has a first value, and a continuity rate of the conductive component in the plan view as seen from the second axial direction in the second region has a second value, the first value being greater than the second value.

### BACKGROUND OF THE INVENTION

### Technical Field

The present invention relates to a multilayer ceramic capacitor and a circuit board having the same mounted thereon.

### Background Art

A multilayer ceramic capacitor includes, for example, a ceramic body having stacked internal electrodes alternately drawn out to a pair of end surfaces and ceramic layers disposed between the internal electrodes, and a pair of external electrodes respectively covering the pair of end surfaces and connected to the internal electrodes (see Patent Documents 1 and 2). Edge portions of the internal electrodes other than the lead-out edges connected to the external electrodes are covered with margin portions made of ceramics.

The edge of the internal electrode covered with the margin portion can be positioned at the periphery of the region facing the internal electrode adjacent in the stacking direction. For this reason, it is known that the electric field formed between the adjacent internal electrodes concentrates at the edges, and dielectric breakdown is likely to occur. For example, Patent Document 1 discloses a technique for reducing electric field concentration at the edge of an internal electrode pattern by making the thickness of the ceramic layer in the peripheral portion of the internal electrode pattern thicker than the thickness of the ceramic layer in the central portion. For example, Patent Document 2 discloses a technique for suppressing generation of cracks at the outer peripheral edge of the internal electrode and thereby suppressing a decrease in withstand voltage by setting the porosity within the range of 5 to 15% in a region defined by multiplying the thickness of the internal electrode by 20 from the outer peripheral edge of the internal electrode. This structure is realized by moving the co-material of ceramic powder contained in the internal electrode from the central portion of the internal electrode to the outer peripheral edge thereof.

### RELATED ART DOCUMENT

### Patent Document

Patent Document 1: Japanese Patent Application Laid-Open Publication No. 2004-111489
Patent Document 2: Japanese Patent Application Laid-Open Publication No. 2007-335726

### SUMMARY OF THE INVENTION

However, in the technique described in Patent Document 1, since the central portion of the laminate is pressed more strongly than the peripheral portion, the adhesiveness of the peripheral portion of the laminate including the margin portion is reduced, and there is concern about delamination, cracks, and the like. With the technique described in Patent Document 2, the porosity in the central portion of the internal electrode can be low. As a result, there are concerns for delamination due to a decrease in adhesion between the ceramic layers and the internal electrodes and cracks due to the difference in contraction rate during firing between the central portion of the internal electrodes and the ceramic layers.

Moreover, in recent years, multilayer ceramic capacitors have been installed in electronic devices that require particularly high reliability, such as electric vehicles and medical equipment. Therefore, there is a demand for highly reliable multilayer ceramic capacitors that can effectively suppress a decrease in insulation resistance.

In view of the circumstances as described above, an object of the present invention is to provide a highly reliable multilayer ceramic capacitor and a circuit board having the same mounted thereon.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a multilayer ceramic capacitor, comprising: a ceramic body having first and second end surfaces perpendicular to a first axial direction, the ceramic body including: a capacitance forming portion including a first internal electrode drawn out to the first end surface, a second internal electrode drawn out to the second end surface and facing the first internal electrode in a second axial direction perpendicular to the first axial direction, and a ceramic layer disposed between the first and the second internal electrodes, and a margin portion that includes a first end margin portion arranged between the first end surface and the second internal electrode, a second end margin portion arranged between the second end surface and the first internal electrode, and first and second side margin portions respectively arranged on both sides, in a third axial direction orthogonal to the first and second axial directions, of the capacitance formation portion; and first and second external electrodes respectively covering the first and second end surfaces of the ceramic body, wherein each of the first and second internal electrodes has an edge that includes a lead edge in contact with the first or second external electrode at the first or second end surface and a margin edge running along and in contact with the margin portion, and each of the first and second internal electrodes has a first region arranged along the margin edge and a second region arranged at inner sides of the first region in the first and third directions, and wherein each of the first and second internal electrodes includes a conductive component, and a continuity rate of the conductive component in a plan view as seen from the second axial direction in the first region has a first value, and a continuity rate of the conductive component in the plan view as seen from the second axial direction in the second region has a second value, the first value being greater than the second value.

In the above configuration, the first value of the continuity rate of the first region arranged along the margin edge of the internal electrode is higher than the second value of the continuity rate in the second region. As a result, spheroidization of the conductive component at and near the margin edge is suppressed, and dielectric breakdown due to electric field concentration can be suppressed. In addition, by making the second value of the continuity rate in the second region relatively low, the adhesion between the ceramic layer and the second region can be improved, and the sintering behavior of these elements can be brought closer to each other. As a result, delamination, cracks, and the like in the ceramic body can be suppressed, and leakage current accompanying these structural defects can also be suppressed. Therefore, with the above configuration, it is possible to suppress the deterioration of the insulation resistance of the multilayer ceramic capacitor and improve the reliability.

Here, the margin edge of each of the first and second internal electrodes may include a pair of side edges contacting the first and second side margin portions, respectively, and an end edge contacting the first or second end margin portion. In each of the first and second internal electrodes, the first region may include a pair of side regions each positioned within 10% of a width dimension in the third axial direction of the first or second internal electrode from the corresponding side edge, and an end region located within 10% of a length dimension of the first or second internal electrode in the first axial direction from the end edge. In each of the first and second internal electrodes, the second region may occupy an entire region of the first and second internal electrodes that excludes the first region.

As a result, the region where the electric field is particularly likely to concentrate can be designated as the first region, and dielectric breakdown due to the concentration of the electric field can be effectively suppressed. In addition, by occupying a wide range of the internal electrodes with the second regions, it is possible to enhance the effect of suppressing structural defects such as delamination and cracks in the ceramic body. Therefore, the above configuration can effectively improve the reliability of the multilayer ceramic capacitor.

Here, the continuity rate in the first group may be measured in one of the side regions or end region, or in one of the side regions and the end region and is averaged to yield the first value.

Here, the second value may be 70% or more. With this condition, it becomes easier to obtain a multilayer ceramic capacitor that has sufficient capacitance and good frequency characteristics such as impedance and Q value.

The continuity rate of the conductive component may gradually decrease from the first region toward the second region. With this condition, the stress concentration can be alleviated and the reliability of the multilayer ceramic capacitor can be further improved.

Here, the relationship, 0<a−b≤6.8 may be satisfied, where a value obtained by omega-converting the first rate is a, and a value obtained by omega-converting the second value is b.

By satisfying a−b≤6.8, the difference in sintering behavior between the first and second regions due to the difference in continuity is reduced, and the generation of stress at the interface with the ceramic layer and the resulting occurrence of cracks and the like can be suppressed. Therefore, the reliability of the multilayer ceramic capacitor can be more reliably improved.

Here, the continuity rates may be calculated as the ratio of the area of the conductive component remaining undissolved per unit area in each of the first and second regions after the ceramic body is immersed in an etchant that dissolves the ceramic but does not dissolve the conductive component.

This makes it possible to clearly and easily calculate the continuity rates of the conductive component in each of the first and second regions.

Here, the conductive component may include at least one of nickel, copper, palladium, platinum, silver, gold, tin, and an alloy thereof.

Furthermore, the first region may contain as an additive at least one of silver, chromium, iridium, magnesium, molybdenum, osmium, palladium, platinum, rhenium, rhodium, ruthenium, yttrium, and tungsten.

Here, a thickness of the second region in the second axial direction may be 0.2 μm or more and 0.4 μm or less.

Here, a dimension of the multilayer ceramic capacitor in the first axial direction may be 0.4 mm or less, and a dimension of the multilayer ceramic capacitor in the third axial direction may be 0.2 mm or less.

Here, a dimension of each of the first and second side margin portions in the third axial direction may be 30 μm or less. A dimension of each of the first and second end margin portions in the first axial direction may be 30 μm or less.

Here, a thickness of the ceramic layer may be 0.2 μm or more and 0.5 μm or less.

Here, a dimension of the multilayer ceramic capacitor in the second axial direction may be greater than at least one of a dimension of the multilayer ceramic capacitor in the first axial direction and a dimension of the multilayer ceramic capacitor in the third axial direction.

According to the present invention, even in a multilayer ceramic capacitor having such a large dimension in the second axial direction, it is possible to suppress structural defects in the ceramic boy, and the reliability can be improved.

In another aspect, the present invention discloses a circuit board, comprising: a multilayer ceramic capacitor; and a mounting board on which the multilayer ceramic capacitor is mounted, wherein the multilayer ceramic capacitor includes: a ceramic body having first and second end surfaces perpendicular to a first axial direction, the ceramic body including: a capacitance forming portion including a first internal electrode drawn out to the first end surface, a second internal electrode drawn out to the second end surface and facing the first internal electrode in a second axial direction perpendicular to the first axial direction, and a ceramic layer disposed between the first and the second internal electrodes, and a margin portion that includes a first end margin portion arranged between the first end surface and the second internal electrode, a second end margin portion arranged between the second end surface and the first internal electrode, and first and second side margin portions respectively arranged on both sides, in a third axial direction orthogonal to the first and second axial directions, of the capacitance formation portion; and first and second external electrodes respectively covering the first and second end surfaces of the ceramic body, wherein each of the first and second internal electrodes has an edge that includes a lead edge in contact with the first or second external electrode at the first or second end surface and a margin edge running along and in contact with the margin portion, and each of the first and second internal electrodes has a first region arranged along the margin edge and a second region arranged at inner sides of the first region in the first and third directions, and wherein each of the first and second internal electrodes includes a conductive component, and a continuity rate of the conductive component in a plan view as seen from the second axial direction in the first region has a first value, and a continuity rate of the conductive component in the plan view as seen from the second axial direction in the second region has a second value, the first value being greater than the second value.

As described above, according to the present invention, it is possible to provide a highly reliable multilayer ceramic capacitor and a circuit board having the same mounted thereon.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a perspective view of a multilayer ceramic capacitor according to an embodiment of the present invention.

FIG. 2 is a cross-sectional view of the multilayer ceramic capacitor taken along the line A-A′ in FIG. 1.

FIG. 3 is a cross-sectional view of the multilayer ceramic capacitor taken along the line B-B′ of FIG. 1.

FIG. 4 is a cross-sectional view of the ceramic body of the multilayer ceramic capacitor, showing a cross section cut parallel to the X-axis direction (first axial direction) and the Y-axis direction (third axial direction) at the position of the first internal electrode.

FIG. 5 is a cross-sectional view of the ceramic boy of the multilayer ceramic capacitor, showing a cross section cut parallel to the X-axis direction (first axial direction) and the Y-axis direction (third axial direction) at the position of the second internal electrode.

FIG. 6 is a cross-sectional view of a circuit board on which the multilayer ceramic capacitor is mounted.

FIG. 7 is a flow chart showing a method for manufacturing the multilayer ceramic capacitor.

FIGS. 8A-8C are plan views showing manufacturing steps of the multilayer ceramic capacitor.

FIG. 9 is a perspective view showing a manufacturing step of the multilayer ceramic capacitor.

FIGS. 10A-10B are graphs showing the results of the relationship between the differential a−b, where a is an omega-transformed value of the continuity rate A of the first region of the internal electrode and b is an omega-transformed value of the continuity rate B of the second region, and the breakdown voltage (BDV) using the Weibull distribution method for working examples and a comparative example. FIG. 10A shows the result of Weibull α, which is a parameter of the Weibull distribution, and FIG. 10B shows the result of Weibull β, which is another parameter of the Weibull distribution.

### DETAILED DESCRIPTION OF EMBODIMENTS

Hereinafter, embodiments of the present invention will be described with reference to the drawings. In the drawings, X-axis, Y-axis, and Z-axis that are orthogonal to each other are shown as appropriate. The X-axis, Y-axis, and Z-axis define a fixed coordinate system fixed with respect to the multilayer ceramic capacitor 10.

### Overall Configuration of Multilayer Ceramic Capacitor

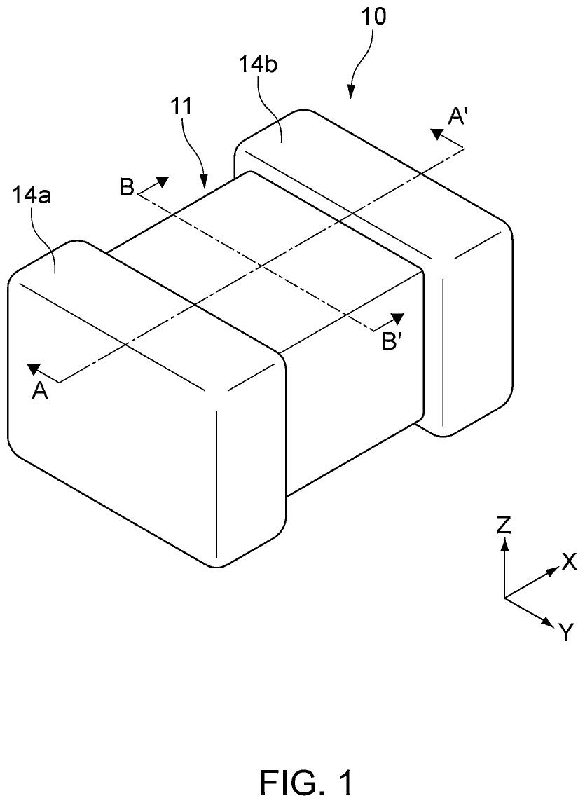

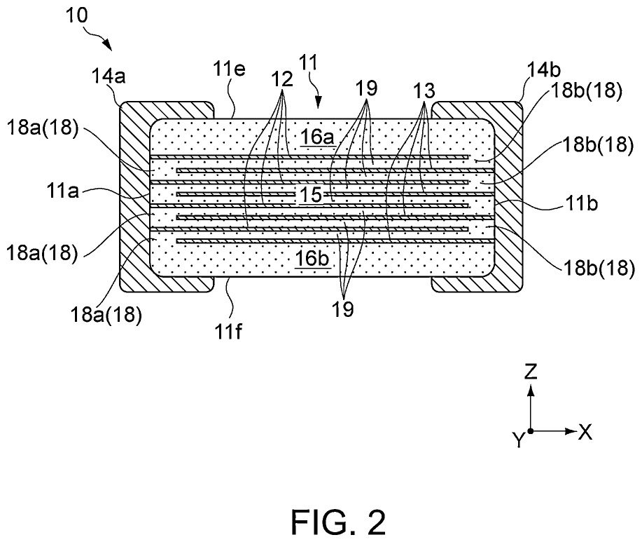

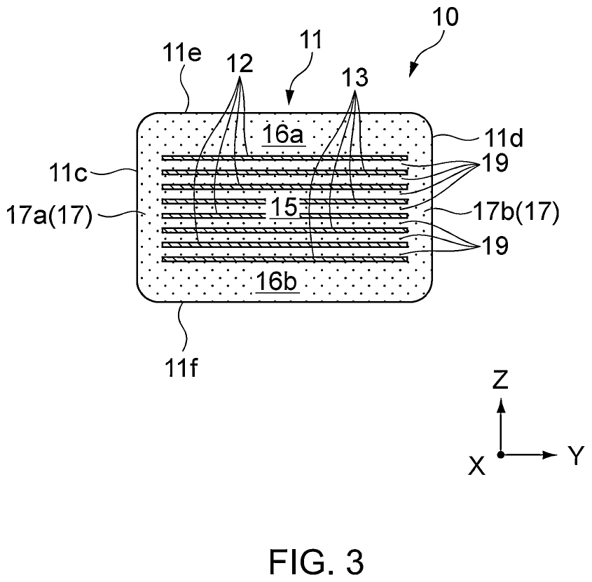

FIGS. 1 to 3 are diagrams showing a multilayer ceramic capacitor 10 according to an embodiment of the present invention. FIG. 1 is a perspective view of a multilayer ceramic capacitor 10. FIG. 2 is a cross-sectional view of the multilayer ceramic capacitor 10 taken along the line A-A′ in FIG. 1. FIG. 3 is a cross-sectional view of the multilayer ceramic capacitor 10 taken along the line B-B′ of FIG. 1.

The multilayer ceramic capacitor 10 includes a ceramic body 11, first external electrodes 14a, and second external electrodes 14b.

The ceramic body 11 has a first end surface 11a and a second end surface 11b perpendicular to the X axis, a first side surface 11c and a second side surface 11d perpendicular to the Y axis, and a first main surface 11e and a second side surface 11d perpendicular to the Z axis. It is configured as a rectangular parallelepiped having two main surfaces 11f. The “rectangular parallelepiped” may be substantially rectangular parallelepiped, and for example, the ridges connecting the surfaces of the ceramic body 11 may be rounded.

The main surfaces 11e and 11f, the end surfaces 111a and 11b, and the side surfaces 11c and 11d of the ceramic body 11 are all flat surfaces. The flat surface according to the present embodiment does not have to be strictly a flat surface as long as it is recognized as flat when viewed as a whole. It also includes surfaces that have a gently curved shape, etc.

The multilayer ceramic capacitor 10 of this embodiment has, for example, the following sizes. The dimension of the multilayer ceramic capacitor 10 in the X-axis direction is, for example, 0.2 mm or more and 4.8 mm or less, and preferably 0.4 mm or less. The dimension of the multilayer ceramic capacitor 10 in the Y-axis direction is, for example, 0.1 mm or more and 3.5 mm or less, and preferably 0.2 mm or less. The dimension of the multilayer ceramic capacitor 10 in the Z-axis direction is, for example, 0.1 mm or more and 3.5 mm or less. Specifically, the size of the multilayer ceramic capacitor 10 is 0.25 mm×0.125 mm×0.125 mm when expressed as (dimension in the X-axis direction)×(dimension in the Y-axis direction)×(dimension in the Z-axis direction), or 0.4 mm×0.2 mm×0.2 mm, etc. The “dimension” of the multilayer ceramic capacitor 10 in one direction is the maximum dimension of the multilayer ceramic capacitor 10 in that direction.

Further, in the following descriptions, the “inside or inner side in the X-axis direction” refers to the side approaching a virtual YZ plane that bisects the multilayer ceramic capacitor 10 in the X-axis direction, and the “outside or outer side in the X-axis direction refers to the side away from the virtual YZ plane. The “inside or inner side in Y-axis direction” refers to the side approaching a virtual XZ plane that bisects the multilayer ceramic capacitor 10 in the Y-axis direction, and the “outside or outer side in the Y-axis direction” refers to the side away from the XZ plane.

The external electrodes 14a and 14b cover both end portions of the ceramic body 11, respectively, in the X-axis direction. For example, the first external electrode 14a shown in FIGS. 1 and 2 extends from the first end surface 11a of the ceramic body 11 to both main surfaces 11e and 11f and both side surfaces 11c and 11d. The second external electrode 14b shown in FIG. 1 extends from the second end surface 11b of the ceramic boy 11 to both main surfaces 11e and 11f and both side surfaces 11c and 11d. However, the shape of the external electrodes 14a and 14b is not limited to this.

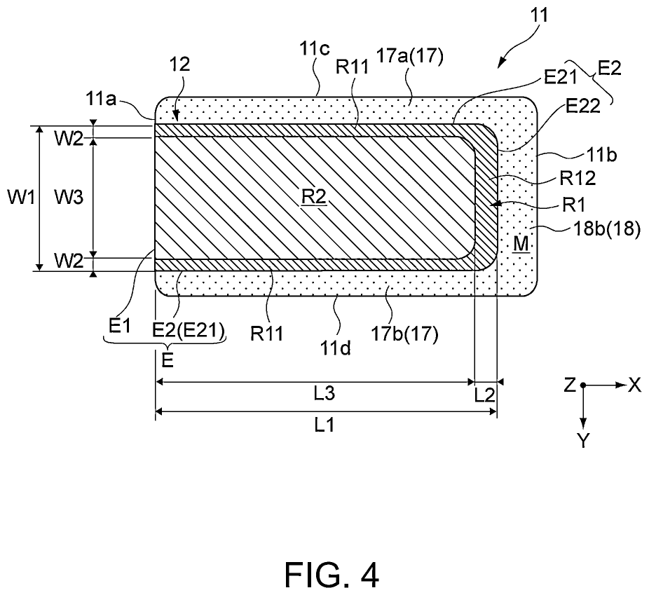

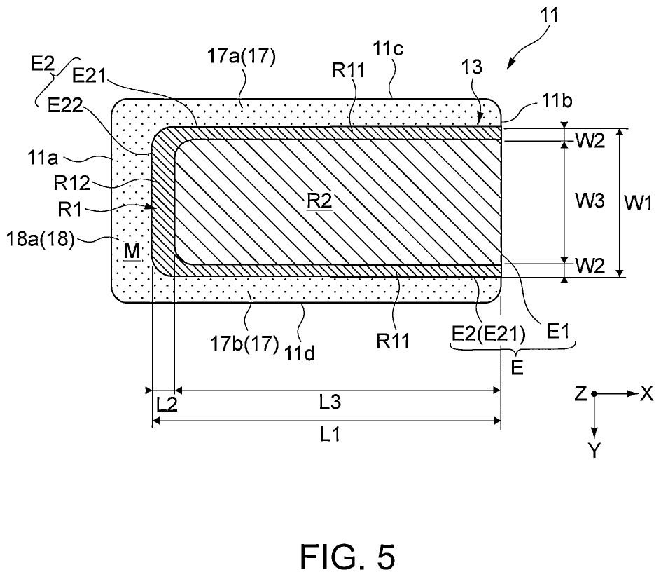

The ceramic body 11 includes a capacitance forming portion 15, a first cover portion 16a, a second cover portion 16b, a first side margin portion 17a, a second side margin portion 17b, a first end margin portion 18a, and a second end margin portion 18b. In this embodiment, the first and second side margin portions 17a and 17b and the first and second end margin portions 18a and 18b constitute the margin portions M of the ceramic body 11 (see FIGS. 4 and 5).

The first and second cover portions 16a and 16b face each other in the Z-axis direction with the capacitance forming portion 15 interposed therebetween, and constitute main surfaces 11e and 11f of the ceramic body 11.

The first and second side margin portions 17a and 17b are arranged on the respective sides of the capacitance forming portion 15 in the Y-axis direction. That is, the first and second side margin portions 17a and 17b face each other in the Y-axis direction with the capacitance forming portion 15 interposed therebetween. The side margin portions 17a and 17b are also called side margin portions 17.

The dimension of each side margin portion 17 in the Y-axis direction can be, for example, 30 μm or less or 20 μm or less in order to achieve miniaturization and large capacitance of the ceramic body 11. The dimension of each side margin portion 17 in the Y-axis direction may be, for example, 5 μm or more to ensure insulation.

The first end margin portion 18a is arranged between the first end surface 11a and the second internal electrode 13. The second end margin portion 18b is arranged between the second end surface 11b and the first internal electrode 12. Each of the end margin portions 18a and 18b is also called an end margin portion 18.

The dimension of each end margin portion 18 in the X-axis direction can be, for example, 30 μm or less or 20 μm or less in order to achieve miniaturization and large capacitance of the ceramic body 11. The dimension of each end margin portion 18 in the X-axis direction may be, for example, 10 μm or more to ensure insulation.

The capacitance forming portion 15 includes ceramic layers 19 and first and second internal electrodes 12 and 13 arranged between the ceramic layers 19. The first internal electrode 12 is drawn out to the first end surface 11a. The second internal electrode 13 is drawn out to the second end surface 11b and faces the first internal electrode 12 in the Z-axis direction. A ceramic layer 19 is arranged between the first and second internal electrodes 12, 13. That is, the first and second internal electrodes 12 and 13 are alternately laminated in the Z-axis direction with the ceramic layers 19 interposed therebetween. In this embodiment, the ceramic layers 19 and the internal electrodes 12 and 13 are both formed in a sheet shape extending along the XY plane.

The internal electrodes 12, 13 contain a conductive component as a main component. The conductive component typically may be nickel (Ni), or may be copper (Cu), palladium (Pd), platinum (Pt), silver (Ag), gold (Au), tin (Sn) and alloys thereof.

The first internal electrodes 12 are connected to the first external electrode 14a at the first end surface 11a. The second end surface 11b side of the first internal electrode 12 is insulated from the second external electrode 14b by the second end margin portion 18b. The second internal electrodes 13 are connected to the second external electrode 14b at the second end surface 11b. The first end surface 11a side of the second internal electrode 13 is insulated from the first external electrode 14a by the first end margin portion 18a.

With such a configuration, in the multilayer ceramic capacitor 10, when a voltage is applied between the external electrodes 14a and 14b, the voltage is applied to the plurality of ceramic layers 19 between the internal electrodes 12 and 13. As a result, the multilayer ceramic capacitor 10 stores an electric charge corresponding to the voltage between the external electrodes 14a and 14b.

The ceramic layer 19 contains dielectric ceramics as a main component. The dielectric ceramics contained in the ceramic layer 19 has, for example, a perovskite structure represented by the general formula ABO₃. Dielectric ceramics having a perovskite structure include, for example, materials containing barium (Ba) and titanium (Ti), typified by barium titanate (BaTiO₃).

Other than barium titanate, the dielectric ceramics may be other composition system, such as strontium titanate (SrTiO₃), calcium titanate (CaTiO₃), magnesium titanate (MgTiO₃), calcium zirconate (CaZrO₃), calcium zirconate titanate (Ca(Ti, Zr, Ti)O₃), barium calcium titanate zirconate ((Ba, Ca)(Ti, Zr)O₃), barium zirconate (BaZrO₃), and titanium oxide (TiO₂).

The compositions of the ceramic layer 19, the cover portions 16a and 16b, the side margin portions 17, and the end margin portions 18 may be the same or different. From the viewpoint of alleviating the stress caused by the difference in physical properties between the capacitance forming portion 15 and its surroundings, the cover portions 16a and 16b, the side margin portions 17, and the end margin portions 18 are preferably made of dielectric material having the same composition as the ceramic layer 19.

The thickness of each ceramic layer 19 in the Z-axis direction can be, for example, 0.2 μm or more and 20 μm or less, preferably 0.2 μm or more and 0.5 μm or less. Thereby, the thickness of each ceramic layer 19 in the Z-axis direction can be made equal to or larger than the grain size of the crystal grains of the dielectric ceramics, and the capacitance can be increased. The thickness of the ceramic layer 19 is the average value of thicknesses measured at multiple locations on the ceramic layer 19. As an example, a cross section of the ceramic body 11 parallel to the Z-axis direction is observed with a SEM (scanning electron microscope) or a TEM (transmission electron microscope). Six layers are selected from the ceramic layers 19 in the field of view, and the thickness of each layer is measured at five evenly spaced points. Then, the thickness of the ceramic layer 19 is defined as the average value of the thicknesses obtained at 30 locations.

### Structure of Internal Electrodes

FIGS. 4 and 5 are cross-sectional views of the ceramic body 11. FIG. 4 shows a cross section cut parallel to the XY plane at the position of the first internal electrode 12, and FIG. 5 shows a cross section cut parallel to the XY plane at the position of the second internal electrode 13. In FIGS. 4 and 5, the internal electrodes 12 and 13 are indicated by hatchings, and the margin portion M is indicated by a dot pattern.

As shown in FIGS. 4 and 5, each internal electrode 12, 13 has an edge E. The edge E is constituted by peripheral portions of the internal electrodes 12 and 13 in the X-axis direction and the Y-axis direction. The edge E includes a lead edge E1 in contact with the first external electrode 14a or the second external electrode 14b and a margin edge E2 in contact with the margin portion M.

The lead edge E1 is an edge of the end portion of the internal electrode 12, 13 in the X-axis direction that contacts the corresponding external electrode 14a, 14b. The lead edge E1 of the first internal electrode 12 is located at the first end surface 11a. The lead edge E1 of the second internal electrode 13 is located at the second end surface 11b. The margin edge E2 is the remaining contour of the edge E excluding the lead edge E1.

In the present embodiment, the margin edge E2 further includes side edges E21 contacting the side margin portions 17 and an end edge E22 contacting the end margin portion 18. In FIGS. 4 and 5, a corner connecting the side edges E21 and the end edge E22 is curved, but is not limited to this and may be angular.

The margin edge E2 is located at the periphery of the region where the internal electrodes 12 and 13 face each other. For this reason, the electric field formed between the internal electrodes 12 and 13 is concentrated, and dielectric breakdown is likely to occur there. In particular, when the thickness of the ceramic layer 19 is reduced due to miniaturization of the multilayer ceramic capacitor 10, dielectric breakdown due to electric field concentration is more likely to occur.

It is considered that the concentration of the electric field at the margin edge E2 is promoted by the spheroidization of the conductive components such as Ni in the internal electrodes 12 and 13. The spheroidization of the conductive component is caused by excessive sintering and resulting shrinkage of the ceramics in the conductive component in the internal electrodes 12 and 13. When the conductive component is spheroidized at the margin edge E2, the spheroidized portion becomes convex, and the local thickness of the ceramic layer 19 can be thinner than the surroundings. This makes dielectric breakdown more likely to occur. Also, a portion of the spherical conductive component is pointed, and the electric field concentrates on that portion, which may cause dielectric breakdown. Furthermore, dielectric breakdown due to such electric field concentration is more likely to occur as the thickness of the ceramic layer 19 is reduced.

On the other hand, in regions where the continuity of the conductive component is high, spheroidization of the conductive component is less likely to occur. Therefore, in this embodiment, the continuity rate of the conductive component is increased along the margin edge E2.

Specifically, in the present embodiment, the internal electrodes 12 and 13 each have a first region R1 arranged along the margin edge E2 and a second region R2 arranged at the inner sides of the first region R1 in the X-axis direction and the Y-axis direction. In FIGS. 4 and 5, the first region R1 is indicated by dense hatching, and the second region 2 is indicated by sparse hatching.

The first region R1 has a first continuity rate A of the conductive component in a plan view. On the other hand, the second region R2 has a continuity rate B of the conductive component in a plan view that is lower than the first continuity rate A. The “plan view” means a planar view of the surfaces of the internal electrodes 12 and 13 extending along the XY plane as viewed in the Z-axis direction.

With this configuration, the continuity rate of the conductive component in the first region R1 along the margin edge E2 is relatively high, and spheroidization of the conductive component in the first region R1 can be suppressed. Therefore, dielectric breakdown at the margin edge E2 can be suppressed, and the reliability of the multilayer ceramic capacitor 10 can be improved.

In addition, the continuity rate of the conductive component is relatively low in the second region R2 at the inner sides of the first region R1 in the X-axis direction and the Y-axis direction. As a result, the ceramic enters into portions where the conductive component of the second region R2 is interrupted, and the adhesion between the ceramic layers 19 and the second region R2 can be enhanced. Therefore, delamination at the interface between the internal electrodes 12, 13 and the ceramic layers 19 can be suppressed.

Also, during firing, stress may occur due to the difference in contraction behavior between the ceramic layers 19 and the internal electrodes 12 and 13 containing the conductive component. In the present embodiment, the proportion of ceramics in the second regions R2 occupying the central portions of the internal electrodes 12 and 13 can be relatively increased, and the shrinkage behavior of the second regions R2 during firing can be brought closer to that of the ceramic layer 19. As a result, the stress generated during sintering can be relaxed at the interface between the internal electrodes 12 and 13 and the ceramic layers 19, and cracks due to the stress can be suppressed.

Thus, in this embodiment, it is possible to suppress leakage current that may occur due to structural defects such as delamination and cracks in the ceramic body 11. Therefore, in the multilayer ceramic capacitor 10, it is possible to suppress a decrease in insulation resistance due to such leakage current.

Furthermore, by relatively lowering the continuity rate of the conductive component in the second region R2, the material cost related to the conductive component is reduced compared to the case where the continuity rate of the entire internal electrodes 12 and 13 is increased. In addition, as will be described later, the internal electrodes 12 and 13 in the present embodiment can be realized by adjusting the coating conditions of the conductive paste and/or by adjusting the firing conditions, etc., without increasing the number of man-hours and the manufacturing cost.

In addition, in the present embodiment, the continuity rates A and B in a plan view as seen from the Z-axis direction are used as the continuity rate of the conductive components of the internal electrodes 12 and 13. That is, the continuity rates A and B are the continuity rates of the internal electrodes 12 and 13 in the XY plane. By using the continuity rate in the XY plane, the effect of suppressing dielectric breakdown in the first region R1 and the effect of suppressing stress at the interface with the ceramic layer 19 in the second region R2 can be adequately evaluated.

An example of a method of calculating the continuity rates A and B in this embodiment will be described.

First, the ceramic body 11 is immersed in an etchant that dissolves ceramics but does not dissolve conductive components. The etchant is, for example, a hydrofluoric acid solution. The concentration of the hydrofluoric acid solution is preferably 2-20%, for example. The immersion time is preferably 12 to 48 hours. As a result, the ceramics of the multilayer ceramic capacitor 10 are melted and the conductive component remains. That is, the co-ceramics and the like contained in the internal electrodes 12 and 13 melt and disappear. The remaining portions of the internal electrodes 12 and 13 made of the conductive component are in a state in which voids are dispersed.

Then, the internal electrodes are taken out from the ceramic body 11 that went through the immersion. Then, with regard to the internal electrodes that have been taken out, the ratio of the area of the undissolved conductive component per unit area in each of the first region R1 and the second region R2 is calculated as continuity rates A and B. For example, the internal electrode after these processes is imaged by SEM at a magnification of 200 to 2000 times. Subsequently, by image processing, the ratio of the area of the conductive component to the entire area in each of the first region R1 and the second region R2 is calculated. The entire area of the first or second region R1, R2 is the area including the voids, and the area of the conductive component is the area of only the conductive component excluding the voids.

Note that the continuity rate A of the first region R1 may be measured in an end region R12 and an side region R11, which will be described later, or may be measured in either one of the end region R12 or the side region R11.

As described above, by the above-described method of melting the ceramics, it is possible to clearly and easily calculate the continuity rates A and B of the conductive components in the plan view for the internal electrodes 12 and 13.

Furthermore, in the present embodiment, the second continuity rate B of the second region R2 is preferably 70% or more. As a result, it is possible to obtain the multilayer ceramic capacitor 10 that has high reliability, sufficient capacitance, and good frequency characteristics such as impedance and Q value.

Also, in the present embodiment, the first continuity rate A of the first region R1 is preferably 95% or less. With this range, it is possible to decrease the burden of applying the conductive paste for increasing the first continuity rate A and avoid increasing the thickness of the first region R1.

On the other hand, the margin edge E2 includes the side edge E21 that contact the first and second side margin portions 17a and 17b, respectively, and an end edge E22 that contacts the end margin portion 18. The side edge E21 is an edge portion of the margin edge E2 that extends, for example, in the X-axis direction. The end edge E22 is an edge portion of the margin edge E2 that extends, for example, in the Y-axis direction.

The first region R1 includes side regions R11, each of which occupies a range within 10% of the width dimension W1 of the internal electrode 12, 13 in the Y-axis direction from the side edge E21, and an end region R12, which occupies a range within 10% of the length dimension L1 in the X-axis direction of the internal electrode 12, 13. In this example, the dimension W2 of each side region R11 in the Y-axis direction is 10% of the width dimension W1 of the internal electrode 12, 13. The dimension L2 of the end region R12 in the X-axis direction is 10% of the length dimension L2 of the internal electrodes 12,13. The width dimension W1 and the length dimension L1 of the internal electrodes 12 and 13 are the maximum dimensions of the internal electrodes 12 and 13 in the Y-axis direction and the X-axis direction, respectively.

In this example, the second regions R2 occupy regions of the internal electrodes 12 and 13 excluding the first regions R1. In other words, the second region R is located in the central portion of the internal electrode 12, 13 in the Y-axis direction, and its dimension W3 in the Y-axis direction is 80% of the width dimension W1 of the internal electrode 12, 13. The dimension L3 in the X-axis direction of the second region R2 is 90% of the length dimension L1 of the internal electrode 12,13.

By setting the range of the first region R1 in this way, it is possible to reliably increase the continuity rate of the region where the electric field tends to concentrate. This can suppress dielectric breakdown that may occur between the side region R11 and/or the end region R12 and the external electrode facing each other. Also, by setting the range of the second region R2 in this manner, the second region R2 occupies a wide range of the internal electrodes 12 and 13. As a result, the effect of reducing the difference in sintering behavior between the internal electrodes 12 and 13 and the ceramic layer 19 and the effect of increasing the adhesion can be sufficiently obtained, and the leakage current caused by delamination and cracks can be effectively reduced. Therefore, this configuration can further improve the reliability of the multilayer ceramic capacitor 10.

Furthermore, in the present embodiment, when the value obtained by omega-converting the first continuity rate A of the first region R1 is a, and the value obtained by omega-converting the second continuity rate B of the second region R2 is b, it is preferable that 0<a−b≤6.8 is satisfied. The omega-transformed values a and b are expressed by the following equations using the continuity rates A and B. The unit of A and B is %, and the unit of a and b is db (decibel).

$$a = 10 \times log ( A / ( 100 - A ) ) \\ b = 10 \times log ( B / ( 100 - B ) )$$

By evaluating the difference a−b between the values a and b obtained by omega-converting the continuity rates A and B, it is possible to evaluate the difference between the continuity rates A and B on a scale that considers the values of the continuity rates A and B more effectively. That is, the value of a−b is an index that reflects a more realistic effect than the value of A−B.

By making a−b greater than 0, the continuity rate A can be made greater than the continuity rate B, and the reliability of the multilayer ceramic capacitor 10 can be improved as described above. In addition, by setting a−b to 6.8 or less, the occurrence of cracks at the interface with the ceramic layer 19 due to the large difference in sintering behavior between the first region R1 and the second region R2 can be suppressed. As a result, the dielectric breakdown voltage (BDV) can be stably increased, and the reliability can be improved, as will be shown in Working Examples described below.

Further, by setting a−b to 2.0 or more and 6.8 or less, the effect of stably increasing the BDV can be obtained more reliably, and the reliability of the multilayer ceramic capacitor 10 can be further improved.

Further, if the continuity rate gradually decreases from the first region R1 toward the second region R2, stress concentration can be alleviated and the reliability of the multilayer ceramic capacitor 10 can be further improved.

Also, for example, the thickness of each of the internal electrodes 12 and 13 in the second region R2 can be set to, for example, 0.2 μm or more and 0.4 μm or less. As a result, the thickness of the internal electrodes 12 and 13 can be reduced while maintaining the second continuity rate B of the second region R2 at, for example, 70% or more. This way, the multilayer ceramic capacitor 10 can have a large capacitance and can be effectively miniaturized.

In the present embodiment, the thickness of each of the internal electrodes 12 and 13 in the first region R1 can be, for example, 1.05 to 1.2 times the thickness in the second region R2. By making the thickness in the first region R1 slightly larger than the thickness in the second region R2, the first continuity rate A in the first region R1 can be made relatively high while reducing distortion of the ceramic body 11 due to in balance in the thickness in the internal electrode 12, 13. Therefore, cracks or the like due to distortion of the ceramic body 11 can be suppressed, and reliability can be improved more reliably.

In order to relatively increase the first continuity rate A of the first region R1, in addition to the method of adjusting the thickness of the first region R1 described above, the firing conditions may be adjusted, or other method can be used. The firing condition adjustment will be described later.

The thickness of each of the first region R1 and the second region R2 of each of the internal electrodes 12 and 13 is the average value of the thickness in the Z-axis direction measured at multiple locations in each region. As an example, the internal electrodes 12 and 13 in the cross section of the ceramic body 11 parallel to the Z-axis direction are observed by SEM or TEM. A field of view including six or more layers in first regions R1 and a field of view including six or more layers in second regions R2 are selected. Six layers are selected from the internal electrodes 12 and 13 in each field of view, and the thickness of each layer is measured at five evenly spaced locations. Then, the average value of the thicknesses at 30 points obtained from one field of view is taken as the thickness of the region included in that field of view. Alternatively, if the dimension in the X-axis direction of the multilayer ceramic capacitor 10 is, for example, 1 mm or more and is easy to handle, the internal electrodes may be taken out from the ceramic body 11 after being immersed in the etching solution, and their thickness can be measured with a contact-type film thickness meter. In this case also, the thickness is calculated by selecting six layers from the internal electrodes 12 and 13 in the same manner as described above; i.e., measuring the thickness at five evenly spaced locations in each layer, and calculating the average value of the thicknesses at 30 locations, thereby obtaining the thickness of the target area.

### Configuration of Circuit Board

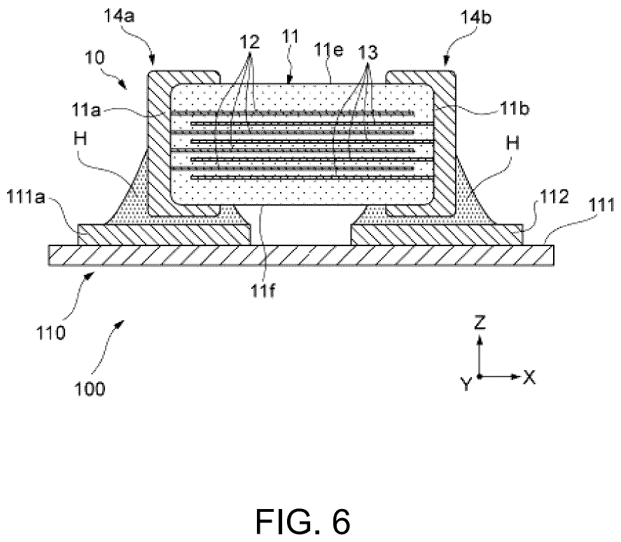

The multilayer ceramic capacitor 10 having the above configuration is mounted on a circuit board 100, for example. FIG. 6 is a cross-sectional view of the circuit board 100 according to this embodiment.

The circuit board 100 has the multilayer ceramic capacitor 10 and a mounting substrate 110 on which the multilayer ceramic capacitor 10 is mounted. The mounting substrate 110 has a mounting surface 111 including lands (connection electrodes) 111a. The external electrodes 14a and 14b of the multilayer ceramic capacitor 10 are connected to the lands 111a by solder H, for example. As a result, the multilayer ceramic capacitor 10 is mounted on the mounting substrate 110 with the second main surface 11f of the multilayer ceramic capacitor 10 facing the mounting surface 111 in the Z-axis direction.

In such a circuit board 100, voltage is applied from the mounting board 110 to the external electrodes 14a and 14b. Since the multilayer ceramic capacitor 10 of the present embodiment can suppress a decrease in insulation resistance as described above, the reliability of the circuit board 100 can also be improved.

### Manufacturing Method of Multilayer Ceramic Capacitor

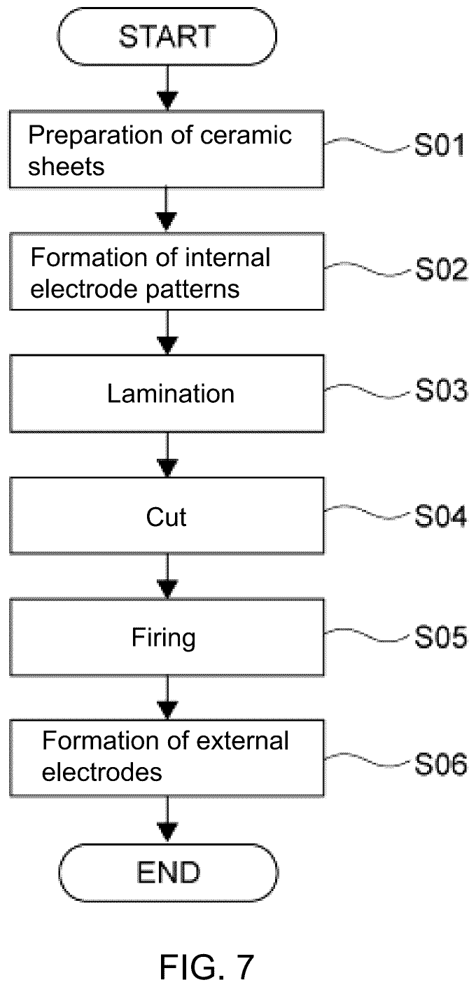

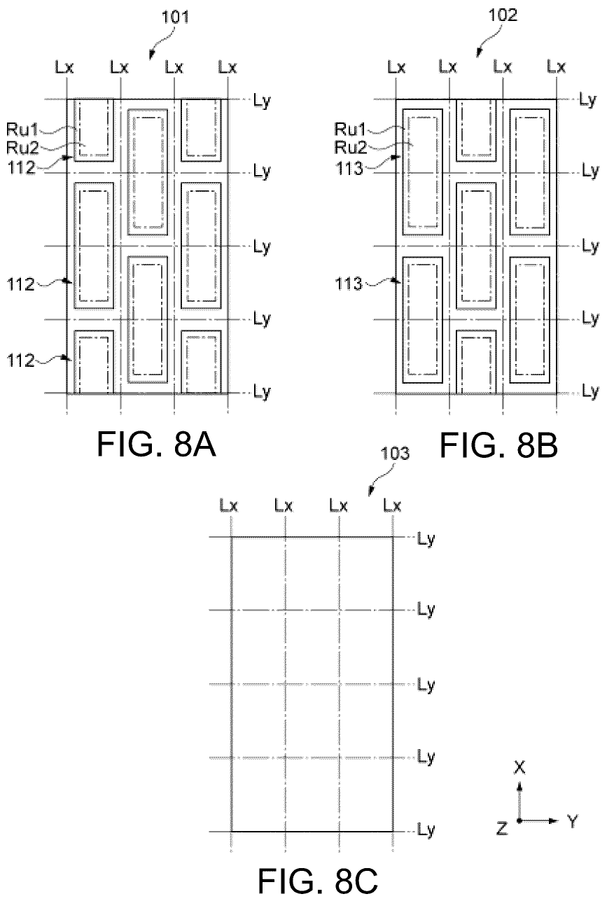

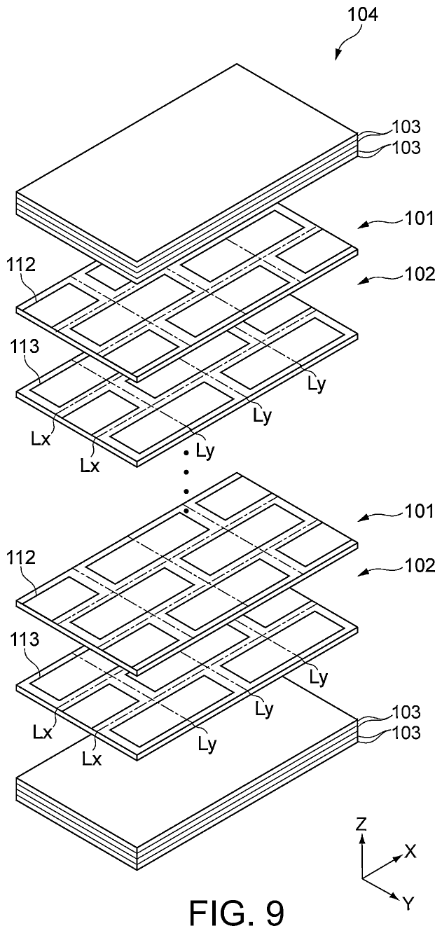

FIG. 7 is a flow chart showing the manufacturing method of the multilayer ceramic capacitor 10. FIGS. 8A-8C and 9 are diagrams showing the manufacturing steps of the multilayer ceramic capacitor 10. Hereinafter, a method for manufacturing the multilayer ceramic capacitor 10 will be described with reference to these drawings.

### Step S01: Ceramic Sheet Preparation

In this step, referring to FIGS. 8A-8C and 9, a first ceramic sheet 101 and a second ceramic sheet 102 for forming the capacitance forming portion 15 and a third ceramic sheet 103 for forming the cover portions 16a and 16b are formed.

The ceramic sheets 101, 102, and 103 in this step are configured as unfired ceramic green sheets on which internal electrodes and the like are not formed. First, the materials for the ceramic green sheets are mixed to obtain a slurry. The materials include dielectric ceramic powder, binder resin, and organic solvent. A slurry obtained by pulverizing and mixing these materials is formed into a sheet by using a doctor blade method, a die coater method, a gravure coater method, or the like.

The thicknesses of the first and second ceramic sheets 101 and 102 are adjusted according to the thickness of the ceramic layers 19 after firing. The thickness of the third ceramic sheet 103 is appropriately adjusted according to the thickness of the cover portions 16a and 16b after firing.

### Step S02: Internal Electrode Pattern Formation

In this step, referring to FIGS. 8A-8C, internal electrode patterns 112 and 113 are formed on the first and second ceramic sheets 101 and 102, respectively, for forming the capacitance forming portion 15.

The internal electrode patterns 112, 113 are formed by applying a conductive paste to the ceramic sheets 101, 102. The first internal electrode pattern 112 corresponds to the first internal electrode 12 and is formed on the first ceramic sheet 101. The second internal electrode pattern 113 corresponds to the second internal electrode 13 and is formed on the second ceramic sheet 102.

The conductive paste used for the internal electrode patterns 112, 113 contains, for example, conductive powder, binder resin, organic solvent, and the like. The conductor powder is composed of nickel (Ni), copper (Cu), palladium (Pd), platinum (Pt), silver (Ag), gold (Au), mixtures, alloys thereof, or the like. Furthermore, the conductive paste preferably contains a ceramic material as a co-material. The ceramic material is, for example, powder of dielectric ceramics.

On each of the ceramic sheets 101, 102, 103 shown in FIGS. 8A-8C, cut lines Lx, Ly are shown for separating the ceramic body 11 into individual pieces. Each of the internal electrode patterns 112 and 113 is configured, for example, in a rectangular shape extending across one cut line Ly. The second internal electrode pattern 113 is formed so as to be shifted from the first internal electrode pattern 112 by one chip interval in the X-axis direction or the Y-axis direction.

In the present embodiment, the peripheral region Ru1 along the ends of the internal electrode patterns 112 and 113 in the X-axis direction and the Y-axis direction is preferably formed thicker than the inner region Ru2 inside in the X-axis direction and the Y-axis direction. The peripheral region Ru1 is a region corresponding to the first region R1, and the inner region Ru2 is a region corresponding to the second region R2. Specifically, for example, the conductive paste may be applied multiple times to the peripheral region Ru1.

For example, the thickness of the peripheral region Ru1 in the Z-axis direction can be 1.05 to 1.2 times the thickness of the inner region Ru2 in the Z-axis direction. As a result, the first continuity rate A in the first region R1 after baking will be relatively increased.

### Step S03: Lamination

In this step, as shown in FIG. 9, the ceramic sheets 101, 102, and 103 are laminated to produce laminated sheets 104.

In the laminated sheets 104 shown in FIG. 9, the ceramic sheets 101 and 102 forming the capacitance forming portion 15 are alternately laminated, and the third ceramic sheets 103 are laminated above and below in the Z-axis direction. These ceramic sheets 101, 102, 103 are integrated by being pressure-bonded. The respective numbers of ceramic sheets 101, 102, 103 are not limited to the example shown in FIG. 9.

### Step S04: Cut

In this step, the unfired ceramic body 11 is produced by cutting the laminated sheets 104 along the cut lines Lx and Ly. For cutting, a method such as pressure cutting or blade dicing can be used.

### Step S05: Firing

In this step, the unfired ceramic body 11 is sintered. Thereby, the ceramic body 11 shown in FIGS. 1 to 3 is produced.

The sintering temperature can be determined based on the sintering temperature of the ceramic body 11. For example, when a barium titanate (BaTiO₃)-based material is used, the firing temperature can be about 1000 to 1350° C. Also, the firing can be performed, for example, in a reducing atmosphere or in a low oxygen partial pressure atmosphere.

In the present embodiment, in addition to increasing the thickness of the peripheral region Ru1 described above, by adjusting the firing conditions as follows, the first region R1 having relatively high continuity can be formed. Specifically, in the temperature rising process, it is preferable to maintain a low temperature range (for example, 800° C. or lower) for a long time (for example, 95 minutes or more) in which shrinkage of the internal electrodes does not start. As a result, the organic substances in the conductive paste can be sufficiently removed. Moreover, it is preferable to shorten the firing time in a high temperature range (for example, 800 to 1350° C.) where shrinkage of the internal electrodes starts and sintering progresses. It is also preferable that the high temperature range firing be performed in a stronger reducing atmosphere than for the low temperature range firing. With these measures in the high temperature range, spheroidization in the first regions R1 of the internal electrodes 12 and 13 can be suppressed.

### Step S06: External Electrode Formation

In this step, the multilayer ceramic capacitor 10 shown in FIGS. 1 to 3 is produced by forming external electrodes 14a and 14b on the respective ends of the fired ceramic body 11 in the X-axis direction. A method for forming the external electrodes 14a and 14b in this step can be adequately selected from known methods. For example, a conductive paste is applied to both ends of the ceramic body 11 in the X-axis direction and baked to form a base film. Subsequently, one or more plating films are formed on this base film.

Through the above steps, the multilayer ceramic capacitor 10 shown in FIGS. 1 to 3 is manufactured. Note that the manufacturing method in this embodiment is not limited to the above example. For example, the application of the conductive paste in step S06 may be performed before the firing process in step S05. In such a case, the base film for the external electrodes can be formed at the same time when the ceramic body 11 is sintered.

### Working Examples and Comparative Examples

Working Examples and a Comparative Example of the above embodiment will be described. In Working Examples 1 to 6, samples of multilayer ceramic capacitors were produced under the condition that the continuity rate A of the first region of the internal electrode was greater than the continuity rate B of the second region. In Comparative Example 1, samples of the multilayer ceramic capacitor were produced under the condition that the continuity rate A of the first region of the internal electrode was smaller than the continuity rate B of the second region. The continuity rates A and B were adjusted by the thickness of the peripheral region of the internal electrode pattern and the firing conditions.

In each of Working Examples 1 to 6 and Comparative Example 1, the sample size of the multilayer ceramic capacitor was 0.4 mm×0.2 mm×0.2 mm. In Working Examples 1 to 6 and Comparative Example 1, the configurations of the samples of the multilayer ceramic capacitor were substantially the same except for the continuity rates A and B.

The continuity rates A and B of Working Examples 1 to 6 and Comparative Example 1 were calculated by the method of immersing the multilayer ceramic capacitor in hydrofluoric acid (etching liquid) described in the above embodiment. The calculated continuity rates A and B were omega-transformed to calculate a and b. Each value for Examples 1 to 6 and Comparative Example 1 is shown in Table 1.

TABLE 1

| | Continuity | Continuity | | | | BDV | BDV |
|---|---|---|---|---|---|---|---|
| Sample | rate A | rate B | a | b | a − b | weibull α | weibull β |
| name | (%) | (%) | (db) | (db) | (db) | (V) | (V) |
| Comparative | 70 | 75 | 3.7 | 4.8 | −1.1 | 289 | 6.1 |
| example 1 | | | | | | | |
| Working | 75 | 70 | 4.8 | 3.7 | 1.1 | 307 | 8.7 |
| Example 1 | | | | | | | |
| Working | 85 | 80 | 7.5 | 6.0 | 1.5 | 294 | 10.9 |
| Example 2 | | | | | | | |
| Working | 90 | 85 | 9.5 | 7.5 | 2.0 | 317 | 16.3 |
| Example 3 | | | | | | | |
| Working | 95 | 90 | 12.8 | 9.5 | 3.2 | 299 | 18.7 |
| Example 4 | | | | | | | |
| Working | 95 | 80 | 12.8 | 6.0 | 6.8 | 318 | 29 |
| Example 5 | | | | | | | |
| Working | 95 | 70 | 12.8 | 3.7 | 9.1 | 300 | 10.4 |
| Example 6 | | | | | | | |

### Evaluation of Dielectric Breakdown Voltage

Subsequently, 20 samples each of Working Examples 1 to 6 and Comparative Example 1 were used to measure the dielectric breakdown voltage (BDV). The BDV was measured by applying a DC voltage at a rate of 10 V/s.

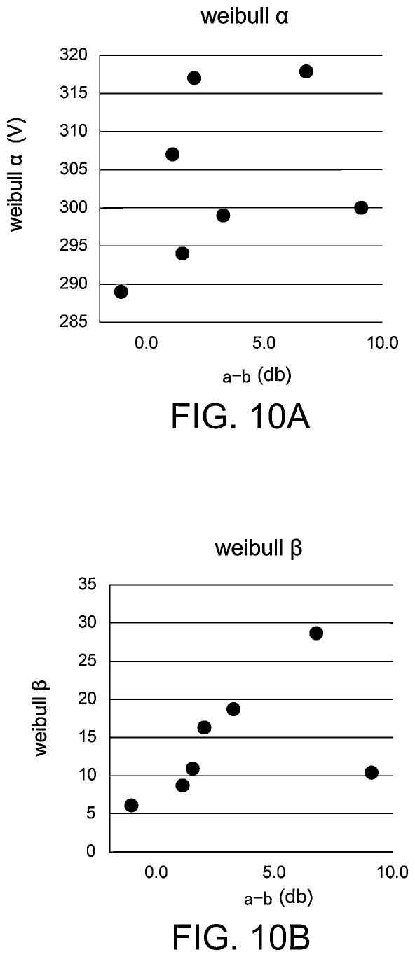

The relationship between a−b and the BDV for each of Working Examples 1 to 6 and Comparative Example 1 was analyzed using the Weibull distribution method. Then, for each of Working Examples 1 to 6 and Comparative Example 1, Weibull α and Weibull β, which are parameters of the Weibull distribution, were calculated. The results are shown in Table 1 and FIGS. 10A-10B.

Note that Weibull α indicates the quantile at which the cumulative failure rate is 63.2%. Weibull β is a value that determines how the hazard (instantaneous failure rate) changes over time.

As shown in Table 1 and FIGS. 10A-10B, for Comparative Example 1 in which the continuity rate A of the first region was smaller than the continuity rate B of the second region and a−b was −1.1, the Weibull α was 289V. On the other hand, the Weibull α of Working Examples 1 to 6, in which the continuity rate A of the first region was larger than the continuity rate B of the second region, was 294 V or more. Accordingly, it was found that the samples of Working Examples 1 to 6 had a higher BDV than the samples of Comparative Example 1.

As shown in Table 1 and FIGS. 10A-10B, the Weibull β of Comparative Example 1, in which the continuity rate A of the first region is smaller than the continuity rate B of the second region and a−b was −1.1, was 6.1. On the other hand, the Weibull β of Working Examples 1 to 6, in which the continuity rate A of the first region was greater than the continuity rate B of the second region, was 8.7 or more. The larger the Weibull β, the smaller the variation in the BDV. From the above results, it was found that the samples of Working Examples 1 to 6 had smaller variation in BDV than the sample of Comparative Example 1, and therefore, they are easy to obtain a stable BDV.

Furthermore, it was found that Working Examples 3 to 5, in which a−b is 2.0 or more and 6.8 or less, all have a Weibull β of 15 or more, and that the variation in BDV can be further reduced.

From these results, it was found that the samples of Examples 1 to 6 were less likely to cause a decrease in insulation resistance than the sample of Comparative Example 1, and had improved reliability.

### Other Embodiments

Although the embodiments of the present invention have been described above, the present invention is not limited to the above-described embodiments, and it goes without saying that various modifications can be made without departing from the gist of the present invention.

For example, the dimension in the Z-axis direction of the multilayer ceramic capacitor may be larger than at least either one of the dimension in the X-axis direction or the dimension in the Y-axis direction of the multilayer ceramic capacitor. In other words, the multilayer ceramic capacitor according to the present invention may be of a high profile type having a dimension ratio in the Z-axis direction that is larger than the sizes exemplified in the above embodiments.

In such a high-profile multilayer ceramic capacitor, the capacitance forming portion including the internal electrodes is thick in the Z-axis direction, and stress is likely to occur due to the difference in sintering behavior between the internal electrodes and the surrounding ceramic portion. In addition, in the above configuration, the number of layers of the internal electrodes increases and the cost of the conductive material used for the internal electrodes tends to increase.

Therefore, in such a configuration, dielectric breakdown in the first region can be suppressed by making the first continuity rate A of the first region of the internal electrode higher than the second continuity rate B of the second region. Furthermore, by making the second continuity rate B of the second region relatively low, it is possible to suppress the cracks and the like caused by the stress, suppress the leak current, and suppress the cost of the conductive material.

Also, as a method for relatively increasing the continuity rate A of the first region R1, a method of increasing the thickness of the first region R1 and adjusting the firing conditions has been mentioned, but the method is not limited to this. For example, the first region R1 and the second region R2 may use conductive pastes with different blending amounts of the ceramic material. In this case, for example, the blending amount of the ceramic material in the conductive paste for forming the first region R1 (peripheral region Ru1) can be changed to be less than the blending amount of the ceramic material in the conductive paste for forming the second region R2 (inner region Ru2).

Further, when the main material of the conductive paste for forming the first region R1 (peripheral region Ru1) and the second region R2 (inner region Ru2) is Ni, for example, as an additive, at least one of silver (Ag), chromium (Cr), iridium (Ir), magnesium (Mg), molybdenum (Mo), osmium (Os), palladium (Pd), platinum (Pt), rhenium (Re), rhodium (Rh), ruthenium (Ru), yttrium (Y) and tungsten (W) may be added only to the first region R1 (peripheral region Ru1). Alternatively, such an additive may be added to both the first region R1 (peripheral region Ru1) and the second region R2 (inner region Ru2). In this case, the content of the additive in the first region R1 may be adjusted to be higher than that in the second region R2.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. A multilayer ceramic capacitor, comprising:
a ceramic body having first and second end surfaces perpendicular to a first axial direction, the ceramic body including:
a capacitance forming portion including a first internal electrode drawn out to the first end surface, a second internal electrode drawn out to the second end surface and facing the first internal electrode in a second axial direction perpendicular to the first axial direction, and a ceramic layer disposed between the first and the second internal electrodes, and
a margin portion that includes a first end margin portion arranged between the first end surface and the second internal electrode, a second end margin portion arranged between the second end surface and the first internal electrode, and first and second side margin portions respectively arranged on both sides, in a third axial direction orthogonal to the first and second axial directions, of the capacitance formation portion; and
first and second external electrodes respectively covering the first and second end surfaces of the ceramic body,
wherein each of the first and second internal electrodes has an edge that includes a lead edge in contact with the first or second external electrode at the first or second end surface and a margin edge running along and in contact with the margin portion, and each of the first and second internal electrodes has a first region arranged along the margin edge and a second region arranged at inner sides of the first region in the first and third directions, and
wherein each of the first and second internal electrodes includes a conductive component, and a continuity rate of the conductive component in a plan view as seen from the second axial direction in the first region has a first value, and a continuity rate of the conductive component in the plan view as seen from the second axial direction in the second region has a second value, the first value being greater than the second value.

2. The multilayer ceramic capacitor according to claim 1,
wherein the margin edge of each of the first and second internal electrodes includes a pair of side edges contacting the first and second side margin portions, respectively, and an end edge contacting the first or second end margin portion, and
wherein in each of the first and second internal electrodes, the first region includes a pair of side regions each positioned within 10% of a width dimension in the third axial direction of the first or second internal electrode from the corresponding side edge, and an end region located within 10% of a length dimension of the first or second internal electrode in the first axial direction from the end edge, and
wherein in each of the first and second internal electrodes, the second region occupies an entire region of the first and second internal electrodes that excludes the first region.

3. The multilayer ceramic capacitor according to claim 2, wherein the continuity rate in the first group is measured in one of the side regions or end region, or in one of the side regions and the end region and is averaged to yield the first value.

4. The multilayer ceramic capacitor according to claim 1, where the second value is 70% or more.

5. The multilayer ceramic capacitor according to claim 1, wherein the continuity rate of the conductive component gradually decreases from the first region toward the second region.

6. The multilayer ceramic capacitor according to claim 1, wherein 0<a−b≤6.8 is satisfied, where a value obtained by omega-converting the first rate is a, and a value obtained by omega-converting the second value is b.

7. The multilayer ceramic capacitor according to claim 1, wherein the conductive component includes at least one of nickel, copper, palladium, platinum, silver, gold, tin, and an alloy thereof.

8. The multilayer ceramic capacitor according to claim 7, wherein the first region contains as an additive at least one of silver, chromium, iridium, magnesium, molybdenum, osmium, palladium, platinum, rhenium, rhodium, ruthenium, yttrium, and tungsten.

9. The multilayer ceramic capacitor according to claim 1, wherein a thickness of the second region in the second axial direction is 0.2 μm or more and 0.4 μm or less.

10. The multilayer ceramic capacitor according to claim 1, wherein a dimension of the multilayer ceramic capacitor in the first axial direction is 0.4 mm or less, and a dimension of the multilayer ceramic capacitor in the third axial direction is 0.2 mm or less.

11. The multilayer ceramic capacitor according to claim 1, wherein a dimension of each of the first and second side margin portions in the third axial direction is 30 μm or less.

12. The multilayer ceramic capacitor according to claim 1, wherein a dimension of each of the first and second end margin portions in the first axial direction is 30 μm or less.

13. The multilayer ceramic capacitor according to claim 1, wherein a thickness of the ceramic layer is 0.2 μm or more and 0.5 μm or less.

14. The multilayer ceramic capacitor according to claim 1, wherein a dimension of the multilayer ceramic capacitor in the second axial direction is greater than at least one of a dimension of the multilayer ceramic capacitor in the first axial direction and a dimension of the multilayer ceramic capacitor in the third axial direction.

15. A circuit board, comprising:
a multilayer ceramic capacitor; and
a mounting board on which the multilayer ceramic capacitor is mounted,
wherein the multilayer ceramic capacitor includes:
a ceramic body having first and second end surfaces perpendicular to a first axial direction, the ceramic body including:
a capacitance forming portion including a first internal electrode drawn out to the first end surface, a second internal electrode drawn out to the second end surface and facing the first internal electrode in a second axial direction perpendicular to the first axial direction, and a ceramic layer disposed between the first and the second internal electrodes, and
a margin portion that includes a first end margin portion arranged between the first end surface and the second internal electrode, a second end margin portion arranged between the second end surface and the first internal electrode, and first and second side margin portions respectively arranged on both sides, in a third axial direction orthogonal to the first and second axial directions, of the capacitance formation portion; and
first and second external electrodes respectively covering the first and second end surfaces of the ceramic body,
wherein each of the first and second internal electrodes has an edge that includes a lead edge in contact with the first or second external electrode at the first or second end surface and a margin edge running along and in contact with the margin portion, and each of the first and second internal electrodes has a first region arranged along the margin edge and a second region arranged at inner sides of the first region in the first and third directions, and
wherein each of the first and second internal electrodes includes a conductive component, and a continuity rate of the conductive component in a plan view as seen from the second axial direction in the first region has a first value, and a continuity rate of the conductive component in the plan view as seen from the second axial direction in the second region has a second value, the first value being greater than the second value.

16. The multilayer ceramic capacitor according to claim 1, wherein for each of the first and second internal electrodes, the continuity rate of the conductive component in each of the first and second regions is determined by immersing the ceramic body in an etchant that dissolves ceramics but does not dissolve the conductive component and by determining a ratio of an area of the conductive component remaining undissolved per unit area in the corresponding first or second region.

17. A multilayer ceramic capacitor, comprising:
a ceramic body having first and second end surfaces perpendicular to a first axial direction, the ceramic body including:
a capacitance forming portion including a first internal electrode drawn out to the first end surface, a second internal electrode drawn out to the second end surface and facing the first internal electrode in a second axial direction perpendicular to the first axial direction, and a ceramic layer disposed between the first and the second internal electrodes, and
a margin portion that includes a first end margin portion arranged between the first end surface and the second internal electrode, a second end margin portion arranged between the second end surface and the first internal electrode, and first and second side margin portions respectively arranged on both sides, in a third axial direction orthogonal to the first and second axial directions, of the capacitance formation portion; and
first and second external electrodes respectively covering the first and second end surfaces of the ceramic body,
wherein each of the first and second internal electrodes has an edge that includes a lead edge in contact with the first or second external electrode at the first or second end surface and a side margin edge running along and in contact with the first and second side margin portions, and each of the first and second internal electrodes has a first region arranged along the side margin edge and a second region arranged at inner sides of the first region in the third direction, and
wherein each of the first and second internal electrodes includes a conductive component, and a continuity rate of the conductive component in a plan view as seen from the second axial direction in the first region has a first value, and a continuity rate of the conductive component in the plan view as seen from the second axial direction in the second region has a second value, the first value being greater than the second value.
